(19) United States
(12) Patent Application Publication
(10) Pub. No.: US 2017/0310927 A1
(43) Pub. Date: Oct. 26, 2017

(54) System And Method For Determining And Overlaying Emotion Animation On Calls

(71) Applicant: Raketu Communications, Inc., New York, NY (US)

(72) Inventors: Martina West, New York, NY (US); Gregory T. Parker, New York, NY (US)

(73) Assignee: Raketu Communications, Inc.

(21) Appl. No.: 15/493,949

(22) Filed: Apr. 21, 2017

Related U.S. Application Data
(60) Provisional application No. 62/327,908, filed on Apr. 26, 2016.

(51) Int. Cl. H04N 7/14; H04L 12/58; G06T 13/80; G06K 9/00; G06T 11/60; H04N 5/272; G10L 25/63

(52) U.S. Cl. CPC H04N 7/141; H04N 5/272; H04L 51/10; G10L 25/63; G06K 9/00275; G06T 11/60; G06K 9/00302; G06T 13/80

(57) ABSTRACT

A method for overlaying or presenting emotion animation in an audio or video call allows a user to select an emotion from a series of presented states of emotion. Alternatively, the system can visually identify the emotional state of the user by sampling various facial points of the user, and using an algorithm to determine facial characteristics to identify the emotional state of the user, or the system can sample the audio and using an algorithm identify the emotional state of the user. Once the emotional state of the user is identified, either by selected or the system determining, the originating device can send an animated representation of the emotion to a second device, which will be overlaid over the incoming video or audio stream and displayed on the second device.

### PRIORITY

This application claims priority from U.S. provisional patent application No. 62/327,908, filed Apr. 26, 2016.

### FIELD OF INVENTION

The present invention relates generally to determining emotional states, animating emotional states, overlaying animated emotional states on video/audio communications, video/audio communications, and augmented reality.

### BACKGROUND

As users become more accustomed to technology and technology related communications, the desire to express and visually show emotion continues to grow.

The vast majority of messaging services support static images within text messages between and amongst users for expressing an emotion or other response. While this may be sufficient within the texting environment, nothing has been developed in the area of augmented video/audio calling for the representation of animated emotions.

Conventional systems of FIG. 1 place static images next to text in an attempt to allow the user to “show” emotion (commonly known as emoticons—or emotion icons). This would be insufficient to “show” emotion when video calls are considered, since it is a visual paradigm not a textual one, and insufficient to “show” emotion when audio calls are considered, since it is an audio paradigm not a textual one. The concept of interactive augmented text simply does not exist as there is no augmentation of textual, non-graphically visual, information.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In the invention, the user either selects a mood or emotion, or the system may determine the user's emotion. The system determination may occur from sampling reference points on the user's face and applying an algorithm which makes a determination of the emotional state of the user, or the system may evaluate other biometric values of the user, such as vocal inflection and tone. Once this selection of emotion has been made or determined, it is relayed to the recipient, or multiple recipients in a group or conference call, whereby the emotional state is displayed as an animated emotion overlaid on the video/audio call display. The sender may also have the animated emotion displayed overlaid on their video/audio call display. The animated emotion may be opaque or optionally transparent, allowing the background visuals to be seen. Further, the display may have enhanced features that allow the sender and/or recipient to interact in an augmented reality with the animated emotional overlay or in the context of the animated emotional overlay. Examples of enhanced features include the ability to send responsive images or gifts between users, based upon an emotional state.

More specifically, the invention facilitates the emotional interaction via visual animations that enhance the video/audio call experience by simulating and augmenting the environment during a communication.

### BRIEF DESCRIPTION OF THE DRAWINGS

FIG. 1 is a diagram/image illustrating a conventional prior art text interaction with static emoticons.

FIG. 2 is a diagram/image illustrating a manual selection of emotional state—an aspect of the present invention.

FIG. 3 is a diagram/image illustrating an automated facial emotion determination selection of emotional state—an aspect of the present invention.

FIG. 4 is a block diagram illustrating sending and receiving the emotional state—an aspect of the present invention.

FIG. 5 is a diagram/image illustrating the rendering and overlay of the animated emotional state—an aspect of the present invention.

FIG. 6 is a diagram/image illustrating interacting in an augmented reality with the animated emotional overlay—an aspect of the present invention.

### DETAILED DESCRIPTION OF THE PREFERRED EMBODIMENT

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well known structures and devices are shown in block diagram form in order to facilitate describing the present invention.

As used in this application, the terms “component” and “system” and “server” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

It is to be appreciated that, for purposes of the present invention, any or all of the functionality associated with modules, systems and/or components discussed herein can be achieved in any of a variety of ways (e.g. combination or individual implementations of active server pages (ASPs), common gateway interfaces (CGIs), application programming interfaces (API's), structured query language (SQL), component object model (COM), distributed COM (DCOM), system object model (SOM), distributed SOM (DSOM), ActiveX, common object request broker architecture (CORBA), remote method invocation (RMI), C, C++, Java, practical extraction and reporting language (PERL), applets, HTML, dynamic HTML, server side includes (SSIs), extensible markup language (XML), portable document format (PDF), wireless markup language (WML), standard generalized markup language (SGML), handheld device markup language (HDML), other script or executable components).

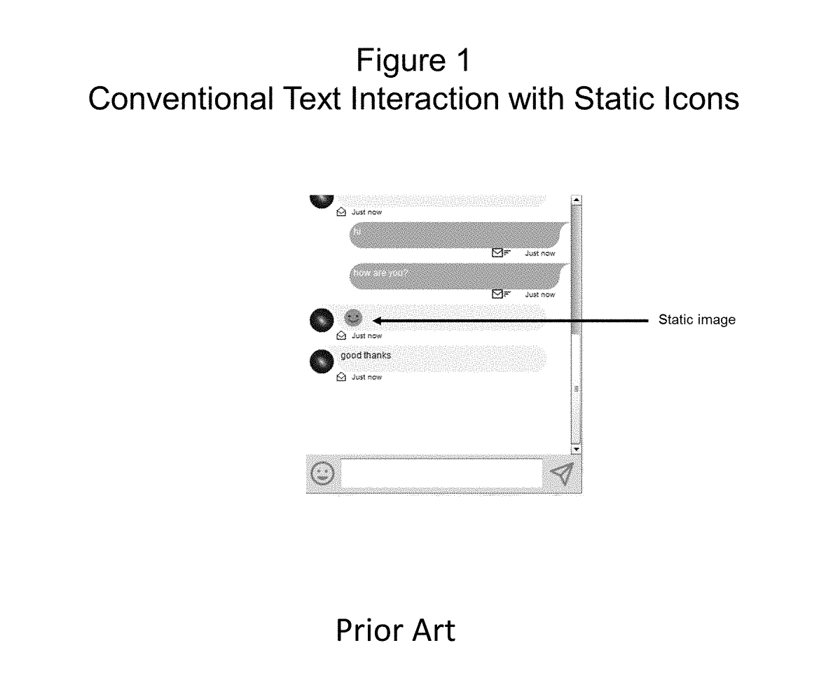

FIG. 1 is a diagram/image of prior art systems, showing a conventional text messaging receiver placing static images next to the text in an attempt to allow the sending user to “show” emotion (commonly known as emoticons—or emotion icons).

The conventional system would be insufficient to “show” emotion when video calls are considered, since video calls are a visual paradigm not a textual one, and similarly, convention systems are insufficient to “show” emotion when audio calls are considered, since it is an audio paradigm not a textual one. The context of video and audio communications provide a more rapid exchange of information than would allow the use of conventional systems of emotion icons. Further, conventional systems require users to use separate communication channels or applications to interact through audio or video calls and text/emoticon transmissions, where the present invention integrates the emotional state with the ongoing audio or video call.

The present invention presents a novel approach to determining emotions, relaying those emotions to others, interpreting those emotions, displaying those emotions, and facilitating interaction based on the emotions and/or the context of those emotions.

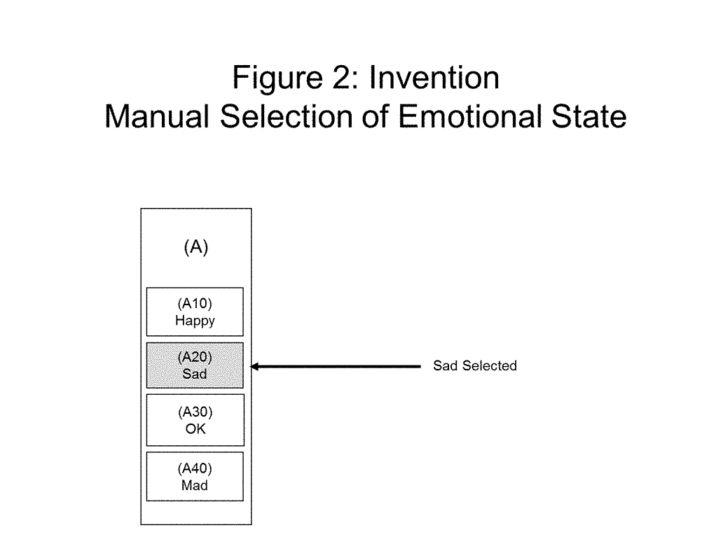

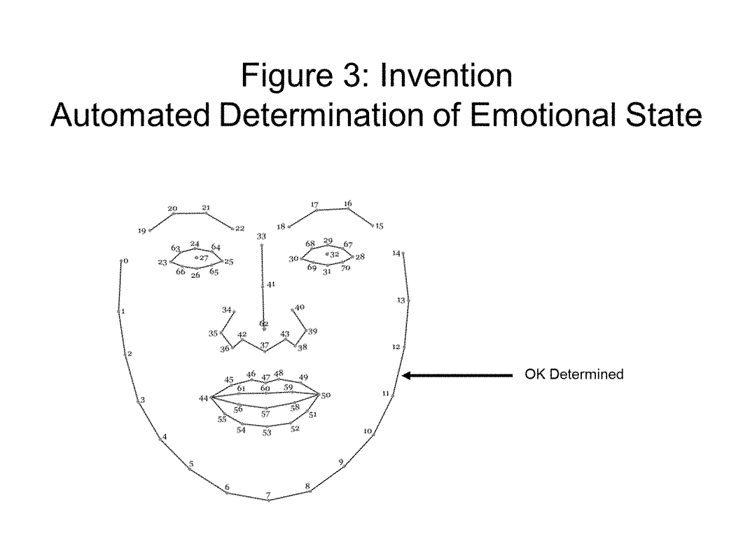

The present invention, as shown in FIG. 2 and FIG. 3, relates to systems and methods for selecting or determining emotional states of a user, either manually, FIG. 2, or through automated facial emotion determination, FIG. 3, or through automated voice emotion determination.

Pursuant to the invention, prior to entering a video or audio call, or while in the video or audio call, the user may manually select the mood or emotion from a set of emotions (example. happy, sad, glad, mad), as shown in FIG. 2. The set of emotions may be established as a database of emotions, or may be user generated. An embodiment of the invention would allow the database of emotions to be supplemented and modified by the user or by a system-wide update.

The system may determine the user's emotion by analyzing the user's biometric information. One example would be the sampling of points on the user's face and applying an algorithm to determine the emotional state of the user, as shown in FIG. 3. In yet another embodiment, the system may determine the emotion from sampling of the audio, or a combination of the foregoing methods. Emotion determination by facial tracking algorithms or audio analysis are known but not applied to audio or video communications.

The present invention, as shown in FIG. 3, facilitates the automated facial emotion determination of the sender and/or the receiver. The emotion is determined from sampling many points on the user's face (including eye positions, open/closed, mouth positions, open/closed, nose positions, eye brow positions, etc. and the distances, relationships, and ratios between these points) and applying an algorithm which makes a determination of the emotional state of the user. The sender's emotion is determined and can be used to automatically select an emotion to send, and the receiver's emotion can be determined as displayed on the sender's device and displayed to the sender (a response emotion). In addition, the sender's automated facial emotion determination can be used in a local fashion, whereby the emotion is determined and displayed to the local user (sender) prior to sending or for the sender's information without sending.

Similarly, the present invention facilitates the automated audio emotion determination of the sender and/or the receiver. The emotion is determined by sampling the audio and applying algorithms that carrying out an acoustic analysis to determine the related emotion state. The sender's emotion is determined and can be used to automatically select an emotion to send, and the receiver's emotion can be determined as displayed on the sender's device and displayed to the sender (a response emotion). In addition, the sender's automated audio emotion determination can be used in a local fashion, whereby the emotion is determined and displayed to the local user (sender) prior to sending or for the sender's information without sending.

As used herein and in the claims, the term “emotion data” refers to the emotional state provided by a user or automatically determined by a device, and transmitted from one device to another.

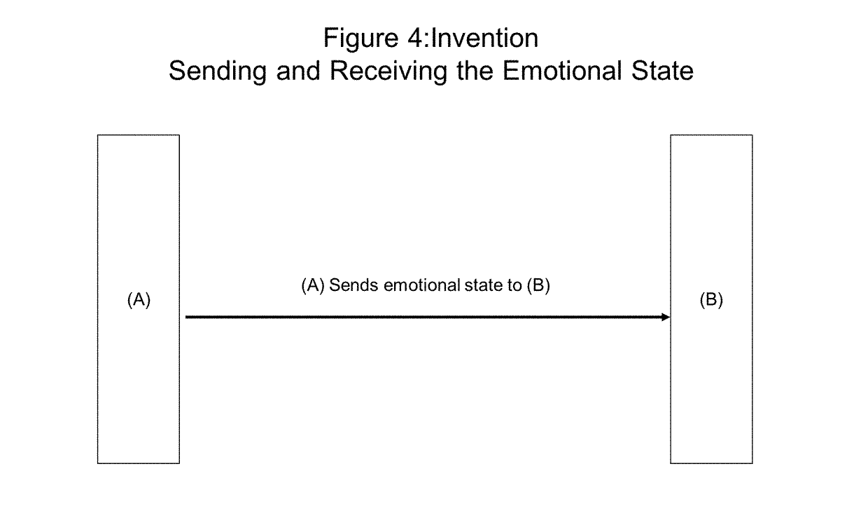

The present invention, as shown in FIG. 4, relates to systems and methods for device A sending the emotional state and device B receiving the emotional state. Once the selection of emotion has been made or determined, the user's emotional state is transmitted to a recipient, or recipients if in a group or conference call. The emotional state may be sent either within the video/audio stream, on another channel, or independently over a separate channel. The animated emotional state may be sent as a complete animated graphic, an internal pointer to an in-memory animated graphic, a pointer to either a locally or remotely stored animated graphic, or may comprise emotional state details which include the type of emotion (e.g. happy, sad, etc.) and at least one attribute or quality of the emotion (e.g. very, slightly, extremely, etc.).

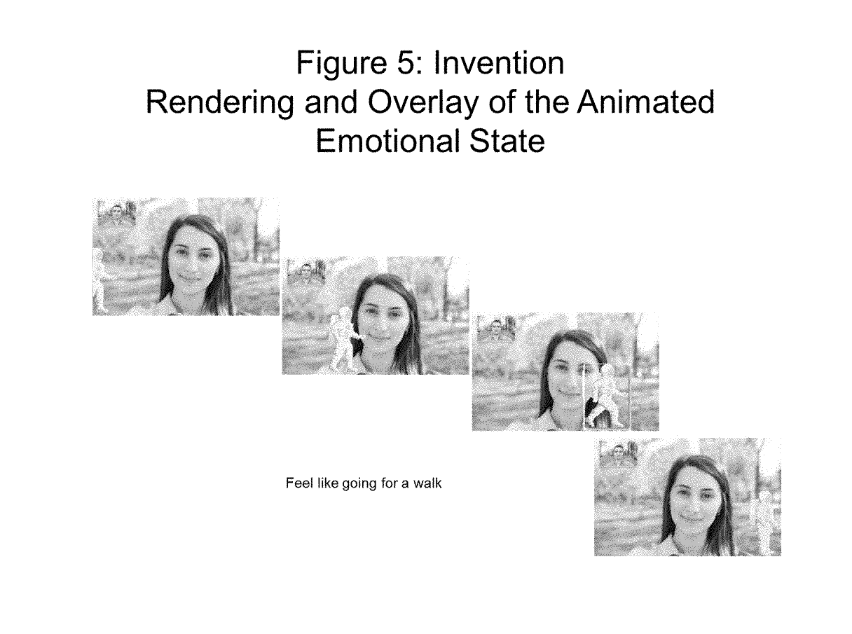

The present invention, as shown in FIG. 5, relates to systems and methods for the recipient device or devices that receive the emotional state to render that emotional state as an animated emotion, opaque or transparent, overlaid on a video/audio call display. The rendering of the animated emotion may be placed on the screen in a certain position, may be moved over the call display area, or may be a full screen animation overlaid over the entire call display area. In a similar fashion, the sender may also have the animated emotion displayed overlaid on their video/audio call display. The choice of animated emotion to display may be determined from a set of display animations which are related to the emotions typically by scale (example: a little happy, happy, very happy, etc.). This set of animations typically begins as a pre-defined set, but can be expanded/replaced by the system and/or the users of the system over time.

The emotional state may be displayed as an animated emotion overlaid on the video/audio call display, as shown in FIG. 5. The sender or original user may also have the animated emotion displayed overlaid on their video/audio call display.

The animated emotion may be opaque, or may be transparent, allowing the background visuals and user's face to be seen. Many different options for the display of the emotion are possible, as are known in the art of displaying images on an audio or video call.

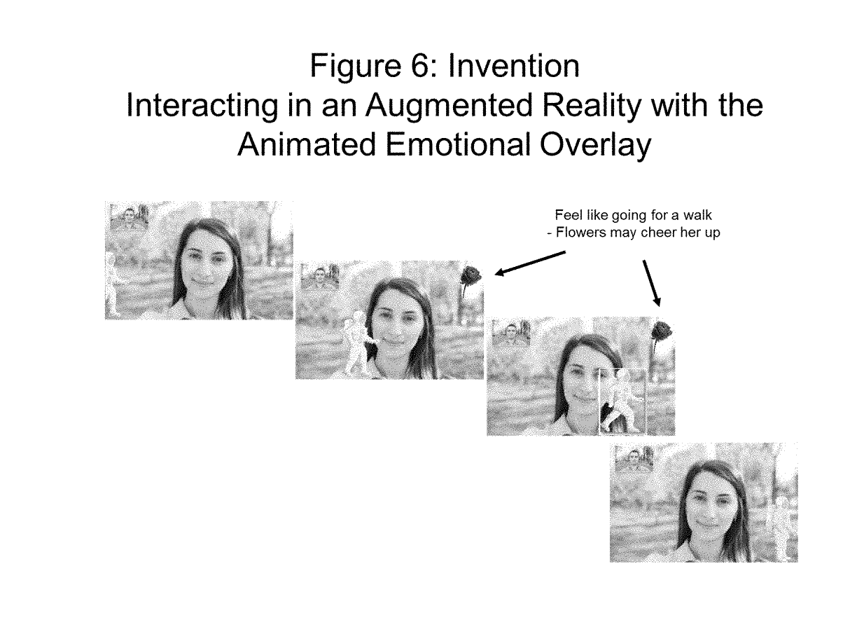

Further, the display may have enhanced features that allow the sender and/or recipient(s) to interact in an augmented reality with the animated emotional overlay or in the context of the animated emotional overlay, as shown in FIG. 6.

More specifically, the invention facilitates the emotional interaction via visual animations that enhance the video/audio call experience by simulating and augmenting the environment during a communication.

Similarly, in the present invention, the recipient may choose to respond to the emotion being conveyed by the original sender, by selecting an appropriate response emotion (example sympathetic, encourage, disagree, unhappy) as shown in FIG. 2, or having the facial/audio emotion automatically determined, by facial mapping as shown in FIG. 3, and sending that emotional state to the original sender, as shown in FIG. 4, whereby the original sender's device renders that emotional state in relation to the recipient's image, as shown in FIG. 5.

The present invention relates to systems and methods for the sender and/or the recipient device or devices that receive the emotional state to interact in an augmented reality with the animated emotional overlay within the video/audio call environment context. Examples of an augmented reality include a live direct or indirect view of a physical, real-world environment. Where the communication between sender and recipient is a video call, the video elements may be augmented or supplemented by computer-generated sensory input such as sound, video, or graphics.

The addition of a representation of an emotional state allows other events and actions to occur, for example, purchasing items that are related to the parties and/or the emotional state being conveyed. The present invention provides the selected or determined emotion, and can optionally combine this information with additional information (example: gender of the sender and/or recipient, location of sender and/or recipient, interests of sender and/or recipient, etc.), to determine events or actions that are associated to and displayed in the augmented video or audio call. These events or actions are stored and retrieved in the context of emotions related to the events or actions, and can be stored in combination with the additional information. Depending on the configuration, the device renders the appropriate visual representations of the events or actions for the user to interact, one example being shown in FIG. 6, where one user applies the animation of taking a walk and the other user “gifts” flowers. By combining the emotion with the related information, the invention presents a more relevant experience to the user.

Conventional systems such as shown in FIG. 1 use static images manually selected by the sender and displayed on the recipient's device intermixed with textual content only. The present invention presents an approach to determining emotions, relaying those emotions to others, interpreting those emotions, displaying those emotions, and facilitating interaction based on the emotions and/or the context of those emotions.

To the accomplishment of the foregoing and related ends, certain illustrative aspects of the invention are described herein in connection with the description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

While certain novel features of the present invention have been shown and described, it will be understood that various omissions, substitutions and changes in the forms and details of the device illustrated and in its operation can be made by those skilled in the art without departing from the spirit of the invention.

I claim:

1. A method for rendering an emotion-related image as part of a communication message between a first device and a second device, the communication message comprising audio data, the method comprising the steps of:
determining an emotional state of a user;
deriving emotion data from the emotional state;
selecting an image file comprising the emotion data on the first device;
transmitting the image file to the second device with the communication message; and
displaying the image file on the second device with the communication message.

2. The method of claim 1, where the image file comprises animation.

3. The method of claim 1, where the communication message comprises video data, and the method further comprises displaying the image file as an overlay on the video data.

4. The method of claim 3, where the overlaid image file is at least partially transparent.

5. The method of claim 1, where the step of determining an emotional state comprises:
performing a scan of a user's face and obtaining mapping data of facial features; and
analyzing the mapping data of facial features to determine an emotional state of the user.

6. The method of claim 1, where the step of selecting emotion data comprises:
analyzing an audio portion of the communication message to determine an emotional state of the user.

7. A method for rendering an emotion-related image as part of a communication message between a first device and a second device, the communication message comprising audio and video data, the method comprising the steps of:
determining an emotional state of a user of the first device;
deriving emotion data from the emotional state;
transmitting the emotion data to the second device with the communication message;
using the emotion data on the second device to select an image file; and
displaying the image file on the second device with the communication message.

8. The method of claim 7, where the image file comprises animation.

9. The method of claim 7, where the display of the image file on the second device comprises an overlay on the video data of the communication message.

10. The method of claim 9, where the overlaid image file is at least partially transparent.

11. The method of claim 7, where the step of determining an emotional state comprises:
performing a scan of a user's face and obtaining mapping data of facial features; and
analyzing the mapping data of facial features to determine an emotional state of the user.

12. The method of claim 7, where the step of determining an emotional state comprises:
analyzing an audio portion of the communication message to determine an emotional state of the user.

13. A method of augmenting a communication message between a first device and a second device, the method comprising:
selecting emotion data on the first device;
transmitting the emotion data to the second device with the communication message;
using the emotion data on the second device to determine an event or action for the communication message; and
displaying the event or action as part of the communication message on the second device.

14. The method of claim 13, where the event or action comprises:
a transaction to be performed by the second device.

15. The method of claim 13, where the step of selecting emotion data comprises determining an emotional state of a user of the first device.

16. The method of claim 15, where the step of determining an emotional state comprises:
performing a scan of a user's face and obtaining mapping data of facial features; and
analyzing the mapping data of facial features to determine an emotional state of the user.

17. The method of claim 15, where the step of determining an emotional state comprises:
analyzing an audio portion of the communication message to determine an emotional state of the user.
